(19) United States
(12) Patent Application Publication
(10) Pub. No.: US 2020/0065394 A1
(43) Pub. Date: Feb. 27, 2020

(54) METHOD AND SYSTEM FOR COLLECTING DATA AND DETECTING DECEPTION OF A HUMAN USING A MULTI-LAYERED MODEL

(71) Applicant: Soluciones Cognitivas para RH, SAPI de CV, Yucatan (MX)

(72) Inventors: Pablo Antonio Vidales Calderon, Richmond Hill (CA); Carlos Vázquez Castellanos, Mexico City (MX); Joy Raj Sen, Huixquilucan (MX)

(73) Assignee: Soluciones Cognitivas para RH, SAPI de CV, Yucatán (MX)

(21) Appl. No.: 16/108,902

(22) Filed: Aug. 22, 2018

(51) Int. Cl. G06F 17/30; G10L 15/26; G10L 25/63

(52) U.S. Cl. CPC G06F 17/3043; G10L 25/63; G10L 15/265; G06F 17/30616

(57) ABSTRACT

A method for detecting deception of an individual, the method including: receiving, in a server that includes at least one processor device and a memory, a first data item from a computing device of the individual, wherein the first data item represents one or more answers to one or more questions presented to the individual by the computing device; converting, by the server, the first data item to structured data if the first data item is unstructured data; and determining, by the server, probability of deception of the individual in their one or more answers based on analysis of the structured data from the first data item.

### FIELD

The present disclosure relates to analysis of data to determine the deception/trustworthiness of an individual.

### BACKGROUND

The Internet enables individuals to participate in the creation and sharing of content in various forms of unstructured data, for example, creating editable text documents, spreadsheets, sharing calendars, notes, chats, pictures, videos, voice recordings, etc. Unstructured content includes, for example, pictures/images, audio recordings, videoconferencing, etc. These types of data elements are considered unstructured because there is an absence of a predefined data model or are not organized in a predefined manner. Applications such as Google Docs, Flickr, and Facebook allow individuals to distribute and share unstructured content. Also, there are products that enable the management, search, and analysis of unstructured data such as IBM's® Watson solutions, NetOwl®, LogRhythm®, ZL Technologies, SAS®, Inxight®, etc. These solutions can extract structured data from unstructured content for business intelligence or analytics and are for general use. However, these products do not detect the deception of an individual by analyzing their answers to questions that are contained in one or more different types of unstructured content such as video, audio recordings, documents, images, etc.

### SUMMARY

An exemplary embodiment of the present disclosure provides a method for detecting deception of an individual, the method including: receiving, in a server that includes at least one processor device and a memory, a first data item from a computing device of the individual, wherein the first data item represents one or more answers to one or more questions presented to the individual by the computing device; converting, by the server, the first data item to structured data if the first data item is unstructured data; and determining, by the server, probability of deception of the individual in their one or more answers based on analysis of the structured data from the first data item.

An exemplary embodiment of the present disclosure provides a server configured to detect deception of an individual. The server includes: a memory; and at least one processor device, wherein the server is configured to: receive a first data item from a computing device of the individual, wherein the first data item represents one or more answers to one or more questions presented to the individual by the computing device, convert the first data item to structured data if the first data item is unstructured data, and determine probability of deception of the individual in their one or more answers based on analysis of the structured data from the first data item.

### BRIEF DESCRIPTION OF THE DRAWINGS

The scope of the present disclosure is best understood from the following detailed description of exemplary embodiments when read in conjunction with the accompanying drawings, wherein:

FIG. 1 is a block diagram illustrating a system hardware architecture in accordance with an exemplary embodiment;

FIG. 2 illustrates the architecture of a server in accordance with an exemplary embodiment;

FIG. 3 illustrates a method according to an exemplary embodiment;

FIG. 4 illustrates a method according to an exemplary embodiment;

FIG. 5 illustrates a method according to an exemplary embodiment;

FIG. 6 illustrates a method according to an exemplary embodiment;

FIG. 7 illustrates a method according to an exemplary embodiment;

FIG. 8 illustrates a multi-layer deception model module in accordance with an exemplary embodiment;

FIG. 9 illustrates a method of determining the competency of an individual in accordance with an exemplary embodiment;

FIG. 10 illustrates a method of calculating a final score for a competency model in accordance with an exemplary embodiment;

FIG. 11 is a flow chart illustrating a method according to an exemplary embodiment;

FIG. 12 illustrates a probability deception matrix in accordance with an exemplary embodiment;

FIG. 13 is a flow chart illustrating a method according to an exemplary embodiment; and

FIG. 14 illustrates a hardware architecture in accordance with an exemplary embodiment.

### DETAILED DESCRIPTION

The present disclosure is directed to a system and method for collecting unstructured data and detecting deception of an individual 100 by analyzing their answers to questions that are contained in one or more different types of unstructured content such as video, audio recordings, documents, images, etc. Specifically, the system and method detects deception using a multi-layered model based on unstructured data such as audio recordings, telephonic conversations, video streams, or text documents such as email, SMS, chats logs, etc. The analysis of such unstructured data can include the use of specific methods for a particular data type, such as psycholinguistics, advanced analytics, cognitive analysis, etc. These methods will convert unstructured data into structured data that is inputted into the multi-layer model that detects deception with a certain level of confidence. In the multi-layer model, the different types of unstructured content are combined to determine a probability of deception in the content analyzed. The probability of deception can be expressed, for example, using a number larger than zero and less or equal to one, with zero indicating no deception. Alternatively, the probability of deception can be expressed based on a letter grade, word, color, or in any other manner. In an exemplary embodiment, the probability of deception is calculated for each of the answers collected during the interview of the individual 100, then it is aggregated for each of the competencies or characteristics that are being evaluated in the assessment, and finally an overall value of deception is calculated for the entire completed interview of the individual 100 (e.g., a candidate for a job, a potential person to date, person questioned by law enforcement/government, etc.). In an exemplary embodiment, some or all of the analysis of the unstructured data can be performed by artificial intelligence.

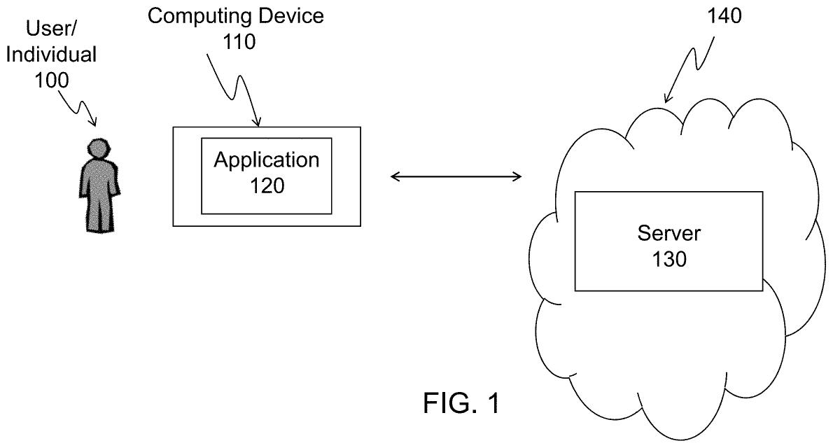

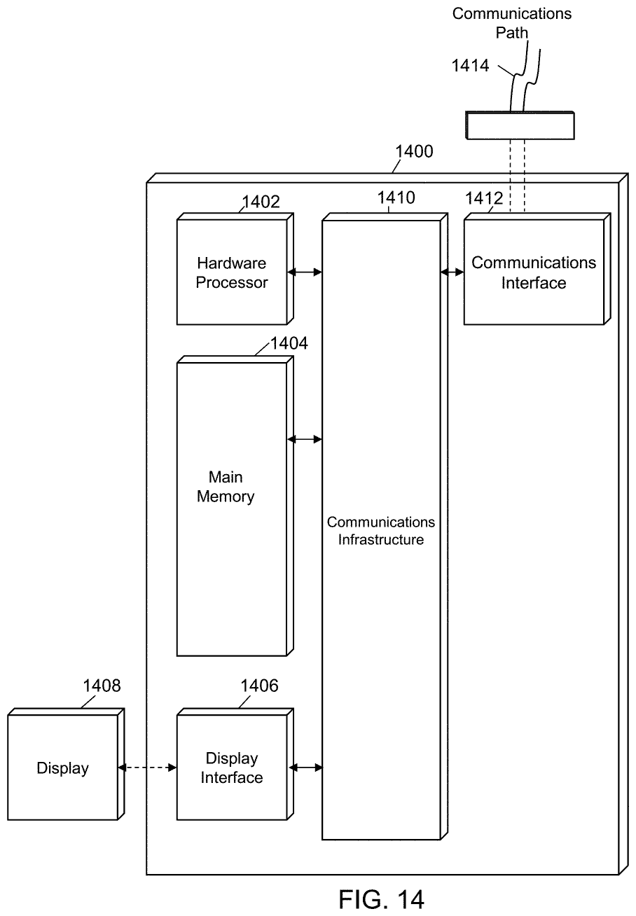

FIG. 1 shows the system for collecting unstructured data and detecting deception of an individual 100 in accordance with an exemplary embodiment. The system includes a computing device 110 that has an application 120 stored thereon, and a server 130. The server 130 can be a cloud computing device and thus stored on a cloud 140. The computing device 110 and the server 130 can communicate with each other via a communications network (e.g., Ethernet, cellular, WiFi, etc.). The computing device 110 can be, for example, a desktop computer, a laptop computer, a smartphone, a tablet, a Personal Digital Assistant (PDA), etc. The components of an exemplary computing device 110 are discussed in greater detail later with respect to FIG. 14. Computing devices 110 such as desktop computers, laptop computers, smartphones, tablets, PDAs, etc. along with existing data exchange networks (cellular networks, Wi-Fi, etc.) enable individuals to create, access, share and edit/access unstructured content anytime and virtually anywhere. It is also possible for users to share unstructured data instantly using data networks and Internet-based applications.

The computing device 110 uses the stored application 120 to perform a real-time interview of the individual 100 which can be, for example, a recording (audio and/or video) or a collection of one-way interactions with the interviewed individual 100. The computing device 110, running the application 120, presents to the individual 100 a set of questions (e.g., with an initial predefined order) and a related instruction on how the answer to the question is to be captured. For example, the answer to the question could be an answer to a multiple choice question, a written text answer to the question inputted by a keyboard or touchscreen, an audio recording of the answer, or a video recording of the answer. In an exemplary embodiment, during the interview, the next question can be selected according to the previous answer. The presenting of questions and the capturing of their answers allows for the collection of unstructured data elements that are inputted into the multi-layer deception model module 204 for deception detection.

The computing device 110 establishes a connection with the server 130 that contains the set of questions that can be presented to the individual 100. The computing device 110 can include one or more of a keyboard, a microphone, and a video camera. The system checks for the availability of the keyboard, microphone and video camera and it configures the interview (i.e., questions) for the individual 100 accordingly. To check which devices among the keyboard, microphone, and video camera are available in the computing device 110, the application 120 uses the available APIs in the supported operating systems (OS). Depending on the type of processing elements (keyboard, microphone, video camera, etc.) that are available in the computing device 110, the answering mode is configured for each of the questions that will be part of the interview. The server 130 can receive text, audio and video data items from the computing device 110. If one processing element is missing (for example, the computing device 110 does not have a video camera), a message is sent/displayed to the individual 100 and the individual 100 can decide to continue the interview with the related restraint (i.e., no video recording) or pause and fix the problem to have a more comprehensive evaluation.

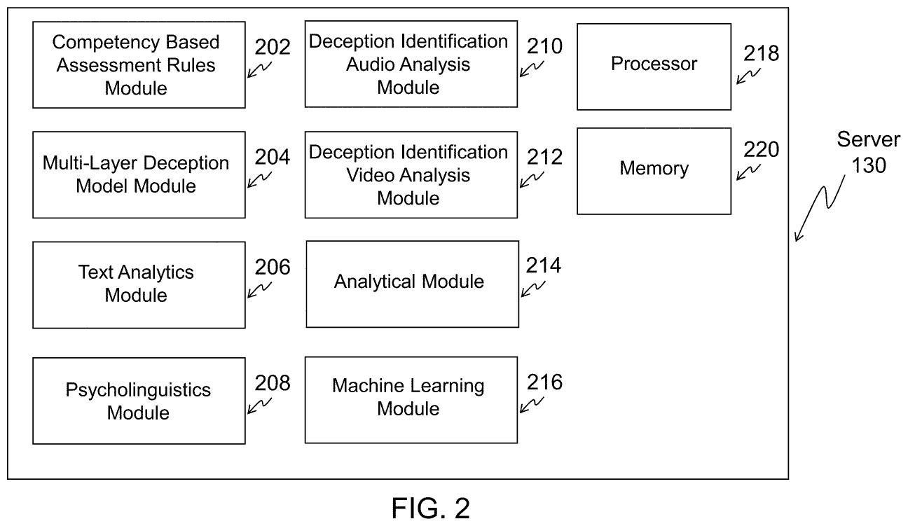

In an exemplary embodiment, the server 130 is configured to detect deception of an individual 100, and the server 130 includes at least one memory 220 and at least one processor device 218. In FIG. 2, in addition to the memory 220 and the at least one processor device 218, the server 130 includes a Competency Based Assessment Rules Module 202, a Multi-Layer Deception Model Module 204, a Text Analytics Module 206, a Psycholinguistics Module 208, a Deception Identification Audio Analysis Module 210, a Deception Identification Video Analysis Module 212, an Analytical Module 214, and a Machine Learning Module 216. These modules will be discussed in detail later. The server 130 is configured to receive a first data item from the computing device 110 of the individual 100. The first data item represents one or more answers to one or more questions presented to the individual 100 by the computing device 110. In an exemplary embodiment, the first data item is an answer to a multiple choice question, the first data item is an answer to the one or more questions provided by the individual 100 in the form of text, the first data item is an audio recording of the individual 100 providing an answer to the one or more questions, or the first data item is a video recording of the individual 100 providing an answer to the one or more questions. The server 130 is also configured to convert the first data item to structured data if the first data item is unstructured data. In addition, the server 130 is configured to determine the probability of deception of the individual 100 in their one or more answers based on analysis of the structured data from the first data item. In an exemplary embodiment, the probability of deception is a number value that indicates a confidence level of the deception (e.g., a value between 0 and 1, between 0 and 10, between 0 and 100, etc.). In an exemplary embodiment, the data items are sent securely (using encryption methods such as the HTTPS protocol) to the server 130 for near-real time analysis (e.g., less than 5 seconds).

In an exemplary embodiment, when the first data item is unstructured data, the server 130 is configured to convert the first data item to structured data, extract parts of the unstructured data or identify characteristics of the unstructured data, and analyze the unstructured data of the first data item.

In an exemplary embodiment, when the first data item is the audio recording of the individual 100 providing the answer to the one or more questions, the server 130 is configured to generate a transcript of the audio recording, analyze the transcript for indications of deception, and analyze the audio recording for indications of deception. The server 130 is also configured to compare a deception event at a time in the transcript to a corresponding time in the audio recording to determine the probability of the deception.

In an exemplary embodiment, when the first data item is the video recording of the individual 100 providing the answer to the one or more questions, the server 130 is configured to separate recorded audio corresponding to the video recording from the video recording, generate a transcript of the recorded audio, and analyze the transcript of the recorded audio for indications of deception. The server 130 is also configured to analyze the audio recording for indications of deception, and analyze the video recording for indications of deception. In addition, the server 130 is configured to compare a deception event at a time in the transcript to a corresponding time in the recorded audio and a corresponding time in the video recording to determine the probability of the deception.

In an exemplary embodiment, the server 130 is configured to receive a second data item from the computing device 110 of the individual 100. The second data item represents one or more answers to one or more questions presented to the individual 100 by the computing device 110. For example, the second data item can be an answer to a multiple choice question, an answer to the one or more questions provided by the individual 100 in the form of text, an audio recording of the individual 100 providing an answer to the one or more questions, or a video recording of the individual 100 providing an answer to the one or more questions. The server 130 is also configured to convert the second data item to structured data if the second data item is unstructured data; and determine the probability of deception of the individual 100 based on the structured data from the first data item and the structured data from the second data item.

In an exemplary embodiment, the first data item is a first type of data, and the second data item is a second type of data. In an exemplary embodiment, the first type of data is one of text data, audio data, or video data and the second type of data is one of text data, audio data, or video data, and the first type of data is different than the second type of data. For example, the first data item could be an answer to a multiple choice question and the second data item could be an answer to the one or more questions provided by the individual 100 in the form of text. For example, the first data item could be an answer to the one or more questions provided by the individual 100 in the form of text and the second data item could be an audio recording of the individual 100 providing an answer to the one or more questions. For example, the first data item could be an audio recording of the individual 100 providing an answer to the one or more questions, and the second data item could be a video recording of the individual 100 providing an answer to the one or more questions. Any other combination is possible.

In an exemplary embodiment, the server 130 is configured to compare structured data from the first data item with structured data from the second data item. For example, the server 130 could compare structured data from a first text data item with structured data from a second text data item.

In an exemplary embodiment, the server 130 is configured to receive a third data item from the computing device 110 of the individual 100. The third data item represents one or more answers to one or more questions presented to the individual 100 by the computing device 110. The server 130 is configured to convert the third data item to structured data if the third data item is unstructured data. Also, the server 130 is configured to determine the probability of deception of the individual 100 based on the structured data from the first data item, the structured data from the second data item, and the structured data from the third data item. The third data item can be an answer to a multiple choice question, an answer to the one or more questions provided by the individual 100 in the form of text, an audio recording of the individual 100 providing an answer to the one or more questions, or a video recording of the individual 100 providing an answer to the one or more questions. In an exemplary embodiment, the first data item, the second data item, and the third date item can all be different types of data (e.g., the first data item could be an answer to a multiple choice question, the second data item could be an answer to the one or more questions provided by the individual 100 in the form of text, and the third data item could be an audio recording of the individual 100 providing an answer to the one or more questions). Any combination of three different data items among the four different data types is possible.

In an exemplary embodiment, the server 130 is configured to receive a fourth data item from the computing device 110 of the individual 100. The fourth data item represents one or more answers to one or more questions presented to the individual 100 by the computing device 110. The server 130 is also configured to convert the fourth data item to structured data if the fourth data item is unstructured data. Also, the server 130 is configured to determine the probability of deception of the individual 100 based on the structured data from the first data item, the structured data from the second data item, the structured data from the third data item, and the structured data from the fourth data item. In an exemplary embodiment, the first data item, the second data item, the third date item, and the fourth data item can all be different types of data (e.g., the first data item could be an answer to a multiple choice question, the second data item could be an answer to the one or more questions provided by the individual 100 in the form of text, the third data item could be an audio recording of the individual 100 providing an answer to the one or more questions, and the fourth data item could be a video recording of the individual 100 providing an answer to the one or more questions).

In an exemplary embodiment, the first data item is an answer to a multiple choice question provided by the individual 100, the second data item is an answer to the one or more questions provided by the individual 100 in the form of text, the third data item is an audio recording of the individual 100 providing an answer to the one or more questions, and the fourth data item is a video recording of the individual 100 providing an answer to the one or more questions.

In an exemplary embodiment, the first data item is in a form of a data file (e.g., audio file, video file, etc.) and the second data item is in a form of a data file (e.g., audio file, video file, etc.).

In an exemplary embodiment, the server 130 is configured to determine whether the computing device 100 has a microphone, video camera, and keyboard or touch screen, and based on this determination the server 130 is configured to determine whether a response to a question presented to the individual will be in the form of an answer to a multiple choice question provided by the individual 100, an answer to a question provided by the individual 100 in the form of text, an audio recording of the individual 100 providing an answer to a question, or a video recording of the individual 100 providing an answer to a question.

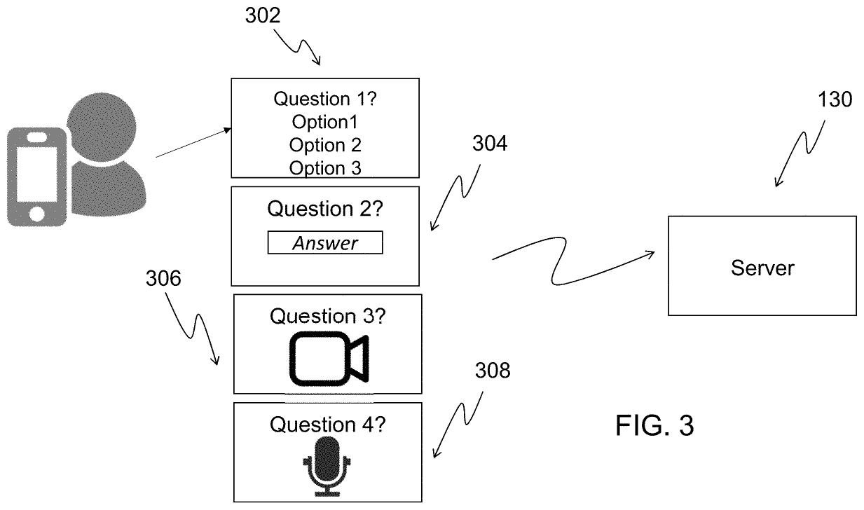

FIG. 3 illustrates a logical view of the application 120 running on the computing device 110, after establishing a connection to the server 130. The application 120 makes a call to the server 130 for the questions that are presented to the individual. There are four possible types of questions that can be presented to the individual 100. The call from the computing device 110 to the server 130 can bring a pre-determined set of questions or get one question as a response, depending on the previous answer. There are multiple choice questions 302 that only require the selection of one answer from a list of potential answers. There are also open-ended questions 304 that require the individual 100 to input their answer in text form using the keyboard or touchscreen (i.e., the individual types the words of their answer using the keyboard). The third type of questions 306 are open-ended questions that invite the individual 100 to generate an answer using the video camera on the device to produce a video file. The last type of questions 308 are open-ended questions in which the individual provides responses using the microphone, and an answer is recorded as an audio file. After each question is presented to the individual 100, the application 120 idles until an answer is received, according to the type of question. The application 120 can receive a selected answer on multiple choice questions, or a text data element, a video file, or an audio file for the open-ended questions. There are two modes of sending data items (i.e., the data containing the answer/answers to a question/questions) to the server 130. The first mode is that each data item collected in the application 120 is sent and stored in the remote server 130 right after the individual 100 completes their answer. The second mode is that multiple data items are stored temporarily in the computing device 110 and then the multiple data items (i.e., multiple answers) are sent together to the server 130. The mode that is used depends on the connectivity of the computing device 110, and the objective is to make sure that there is not a loss of data.

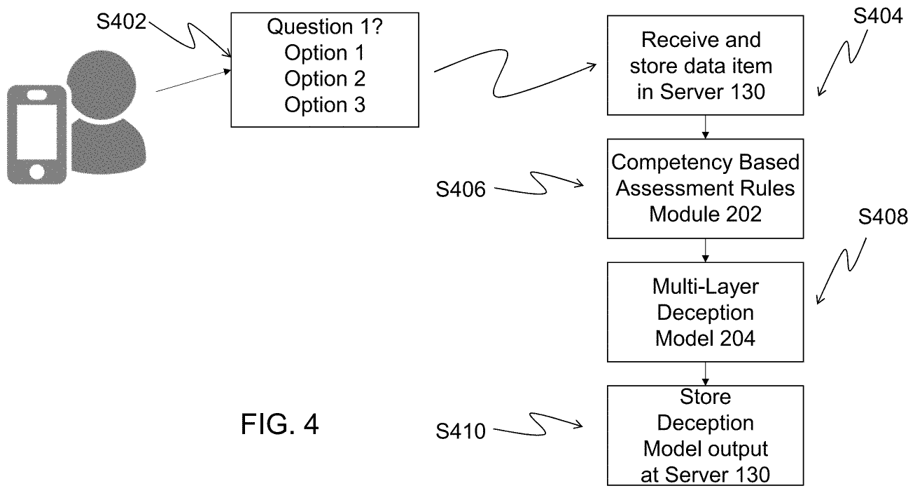

FIG. 4 illustrates the application 120 running on the server 130 for the situation where a multiple choice question is presented to the individual 100. In an exemplary embodiment, the application 120 running on the server 130 includes four different flows, one for each of the modes in which a question can be answered: selection of a multiple choice answer, a text data element, an audio file or a video file. When a multiple choice answer is selected (step S402), the data element for this specific flow is the selected answer out of the possible list of choices. The application 120 in the computing device 110 sends the selected answer (data element/data item component) to the server 130. At step S404, the server 130 receives and stores the data item of the selected answer. At step S406, the data item of the selected answer is communicated to the Competency Based Assessment Rules Module 202. The Competency Based Assessment Rules Module 202 includes a deterministic set of rules defined according to different methodologies used to evaluate competencies of the individual, such as the emotional and social intelligence of the individual. An exemplary methodology is Emotional and Social Competence Inventory (ESCI) which is used to evaluate the emotional and social intelligence of an individual and is described at http://www.eiconsortium.org/measures/eci_360.html, which is hereby incorporated by reference in its entirety. An article by David C. McClelland entitled “Testing for Competence Rather Than for ‘Intelligence,’” American Psychologist, Pages 1-14, 1973, discusses evaluating intelligence and competencies of an individual and is hereby incorporated by reference in its entirety.

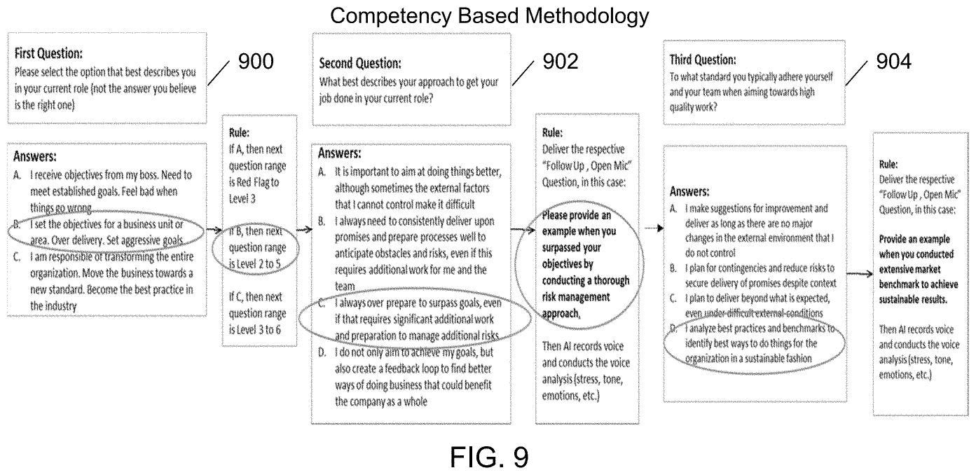

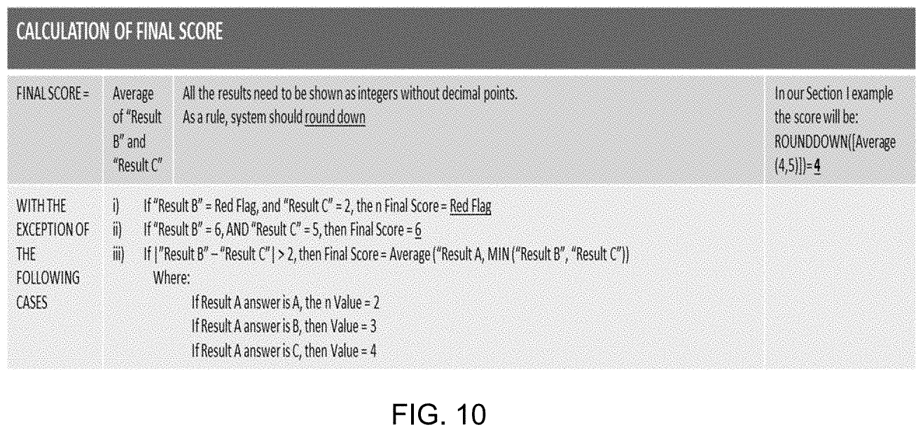

In an exemplary embodiment, the methodology used to define the rules implemented in the Competency Based Assessment Rules Module 202 consists of three questions for each competency that is being evaluated, and is shown in FIG. 9. In this embodiment, three questions are used for each competency, but any number of questions can be used. The first question 900 calibrates the level of responsibility of the individual 100 (as there is a strong correlation between position level and competency level) and sets the interval for the second question 902 which starts evaluating the competency level in more detail. The third question 904 is for calibration purposes (to reduce error margin). The rules define three basic parameters that configure the individual's interview: the type of questions, the answering mode, and the sequence in which the questions are displayed to the individual 100 using the application 120 running on the computing device 110. An exemplary rule is expressed as follows:
Rule 1→FIRST Show multiple choice question 45
Rule 2→IF answer to question 45 is B, THEN show open-ended question 46, request audio file in the answer
Rule 3→IF answer to question 45 is C, THEN show open-ended question 46, request video file in the answer
   Therefore, depending on the answers given by the individual 100, certain rules are triggered to configure the flow of the interview, which is performed by the Competency Based Assessment Rules Module 202. See FIG. 9. The Competency Based Assessment Rules Module 202 also performs the resulting evaluation of the competencies for an individual, and an example calculation is shown in FIG. 10. The exemplary calculation in FIG. 10 shows how the final score is calculated for the sample competency included in FIG. 9, based on multiple choice answers. For the example shown in FIG. 9, there are three levels of questions. In the first level, there are three options, the second question has four options, and the third level also has four options. If lower or higher value options are selected in level one (e.g., options a or c), then a final score is directly calculated as low score 3 and high score 6. If the middle range option is selected (e.g., option b), then there is a follow up flow (second and third level questions), and the options have a minimum value of 2 and a maximum of 5 (there are four choices in each of the follow up questions). The final score is the rounded down average of the two selected options. In the example shown in FIG. 9, this is value 4 in the second level (i.e., second question) and value 5 in the third level (i.e., third question), which is an averaged score of 4.5 that is rounded down to a final score of 4. There are some exceptions in the final score calculation, and these exceptions are implemented with IF-THEN rules. Some examples of exception rules are shown in FIG. 10.

When a rule is triggered, its execution is recorded in a file for the Competency Based Assessment Rules Module 202. This file is communicated as an input to the Multi-Layer Deception Model Module 204. See S408 of FIG. 4. The file contains all of the questions presented to the individual 100, the rules triggered by the interaction with the individual 100, the answer received from the individual 100 to each question, and the score calculated for each of the assessed competencies. This input from the Competency Based Assessment Rules Module 202 is analyzed by the Multi-Layer Deception Model Module 204 in conjunction with input from the other layers of the Multi-Layer Deception Model Module 204, which will be explained in greater detail later. At S410 of FIG. 4, the output of the Multi-Layer Deception Model Module 204 is stored at the server 130.

In an exemplary embodiment, at step S410 of FIG. 4, the Multi-Layer Deception Model Module 204 performs analysis on the information provided from the Competency Based Assessment Rules Module 202. There are different sources of data, as described above, that can be classified in two groups: 1) data used to assess a competency; and 2) data used to calculate confidence level in the answers of the candidate. In the final calculations of the Multi-Layer Deception Model Module 204, these two aspects of the evaluation are combined in order to produce two main outputs: 1) competency level; and 2) confidence level. These two values are associated to each competency present in the evaluation and are calculated for an individual within a defined group of individuals.

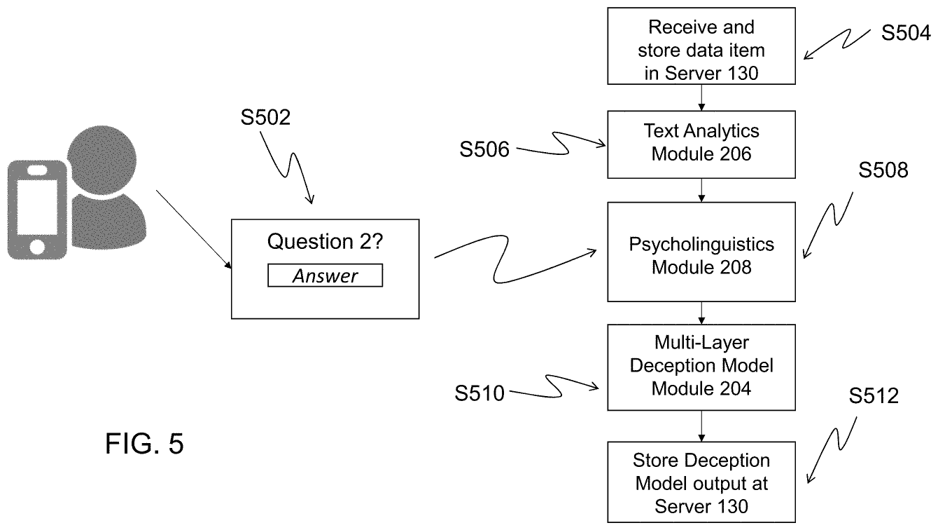

FIG. 5 shows an exemplary process flow of how open-ended questions 304 answered using a keyboard or other input device (e.g., touchscreen, etc.) to generate a text data item are handled by the system. At step S502, the individual answers the open-ended question 304 with a text answer using a keyboard or touchscreen. At step S504, the text data item is transferred from the computing device 110 to the server 130, and the text data item is stored in the server 130. After the text data item is received and stored in the server 130, it is analyzed by the Text Analytics Module 206 at step S506. The Text Analytics Module 206 includes a group of Natural Language Processing (NLP) routines. In an exemplary embodiment, the NLP routines can be the same or similar to those described in the book entitled “Natural Language Processing with Python,” by Steven Bird et al., O'Reilly Media Inc., 2009, which is hereby incorporated by reference in its entirety. In step S506, the analysis process can consist of two main components, the feature extraction layer and the Machine Learning Model 216. The feature extraction layer implements NLP techniques to extract characteristics from the open-ended text answer such as: the number of words, the number of sentences, verb tense, personal pronouns, use of passive voice, etc. Then, these features are used by the Machine Learning Model 216 to estimate a probability of deception of the individual's answer based on the presence or absence of certain patterns such as lack of self-reference. Determining the presence or absence of self-reference can be based on one or more extracted features, for example, lack of self-reference can be found based on the combination of the use of first person pronouns, third person pronouns and use of passive voice. The probability can be defined, for example, as a value between 0 and 1, and it is determined by the occurrence of specific patterns in the answers of the individual and a comparison of the values of a particular individual among a defined group.

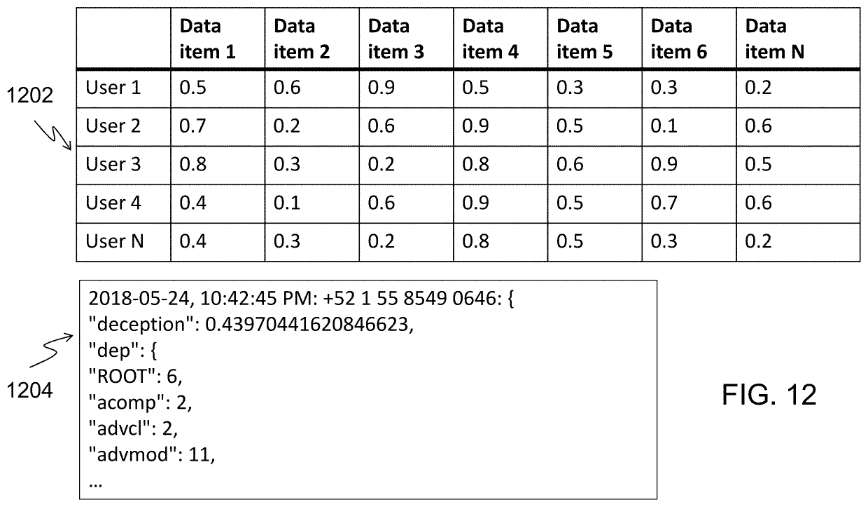

In FIG. 5, an exemplary output of the Text Analytics Module 206 can be an M by N matrix, such as the Deception Probability Ranking Matrix of FIG. 12 where each column represents the analysis of the data item (question), and each row is the evaluation of a particular individual. The output of the Text Analytics Module 206 is also inputted into the Multi-Layered Deception Model Module 204 in FIG. 5 using the Deception Probability Ranking Matrix 1202 depicted in FIG. 12. This matrix 1202 contains the results of analyzing all data items received from one or more individuals. Each of the analysis modules, in this particular flow, the Text Analytics Module 206 that analyzes open-ended text answers, will input a value between 0 and 1 into the Deception Probability Ranking Matrix 1202. The resulting value uses the extracted features to analyze and compare the data item with related open-ended text answers to the same question, made by similar individuals or candidates, and applies certain machine learning techniques to define the value. In FIG. 12, the snippet 1204 that is shown is an extract of an example of code used to calculate deception for text elements. The snippet 1204 includes some of the features extracted from a particular text data element. These values are then ranked to build the Deception Probability Ranking Matrix 1202.

At step S508, using the Psycholinguistics Module 208, an analysis to extract personality traits like openness, extraversion, and agreeableness is performed. Then, these personality traits are correlated to each of the competencies evaluated using the Competency Based Assessment Rules Module 202. The objective of step S508 is to identify strong correlations or potential deviations between competency scores and the extracted personality traits. Using these inputs, a set of rules are defined that will target and identify deviations in the input data. There are two types of rules in the Psycholinguistics Module 208: direct and indirect relation rules. Using direct relation rules, there is a direct mapping between one of the competencies evaluated by the Competency Based Assessment Rules Module 202 and a personality trait extracted from the analysis of the text elements. For example, competency leadership can have values associated with an introvert or an extrovert, and this is also a personality trait that can be extracted from the text analysis. For indirect relation rules, there is no direct relation, but the trait is an aspect of the competency. For example, an extrovert leader can also show openness as a personality trait. In an exemplary embodiment, the extraction of personality traits from text analysis can be performed using third party services (i.e., an API) such as Watson Personality Insights from IBM. In step S510, calculated values from previous process steps are fed into the Multi-Layer Deception Model Module 204, and combined with the rest of the inputs from all data types and data elements. The Multi-Layer Deception Model Module 204 will correlate the different inputs and run the model to output a final Deception Probability Ranking Matrix 1202 shown in FIG. 12. In an exemplary embodiment, the first data item is text data, and personality traits of the individual are extracted based on analysis of the text data.

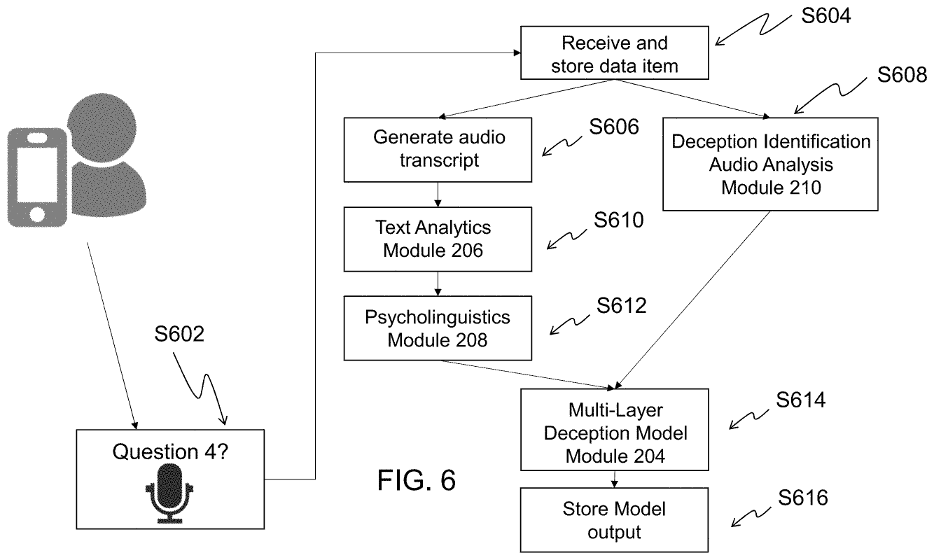

At step S512 of FIG. 5, the output of the Multi-Layer Deception Model 204 is stored in the server 130 or a database. In an alternative embodiment, the feature extraction for the Text Analytics Module 206 could be obtained from a third-party service. The data item could be sent using a secured connection and the third-party service sends back the features required by the Text Analytics Module 206. A third party service could be used for every feature extraction step of the presently disclosed method and system. FIG. 6 shows an exemplary process flow for a data item that is an audio file. In FIG. 6, at step S602, the individual 100 responds to a specific question using the computing device 110, and the computing device 110 records their answer using one or more storage mediums in the computing device 100. The audio file generated by the computing device 110 and containing the individual's answer is sent to the server 130. At step S604, the server 130 receives and stores the audio file data item. After the server 130 receives the audio file data item, the audio file is processed using two separate flows. In one flow, at step S608, the audio data item is analyzed using the Deception Identification Audio Analysis Module 210. The Deception Identification Audio Analysis Module 210 performs audio analysis techniques to extract specific features from the audio file such as, for example, signal energy, loudness, pitch, voice quality, etc. These features are then input to a machine learning module trained to detect deception (e.g., the Machine Learning Model 216). In an exemplary embodiment, the extraction of features from an audio file can be obtained from a third-party solution (i.e., API) such as openSMILE by audEERING™ (https://audeering.com/technology/opensmile/).

The disclosed system uses cross-references in the unstructured data items captured during the individual's interview to increase the deception detection certainty. When analyzing audio data items, cross-referencing is performed by generating an audio transcript (step S606 in FIG. 6) from the audio file and performing the same analysis as at step S506 of FIG. 5 by the Text Analytics Module 206 and at step S508 by the Psycholinguistics Module 208 in steps S610 and S612. The two-flow analysis shown in FIG. 6 advantageously generates cross-references among unstructured data items like discovering correlations between a deception event identified in the audio file and validating it with a corresponding/collocated deception event in the audio transcript. Also, a potential deception event can be identified from the audio file, but there may not be a signal of deception in the corresponding part of the audio transcript, and vice versa. The use of cross-referencing among unstructured data items generates redundancy in the analysis of unstructured data elements, and increases the accuracy of deception detection. Next, at step S614, the output of the analysis of each of the two flows is inputted to the Multi-Layer Deception Model Module 204. At step S616, the output of the Multi-Layer Deception Model Module 204 is stored in the server 130.

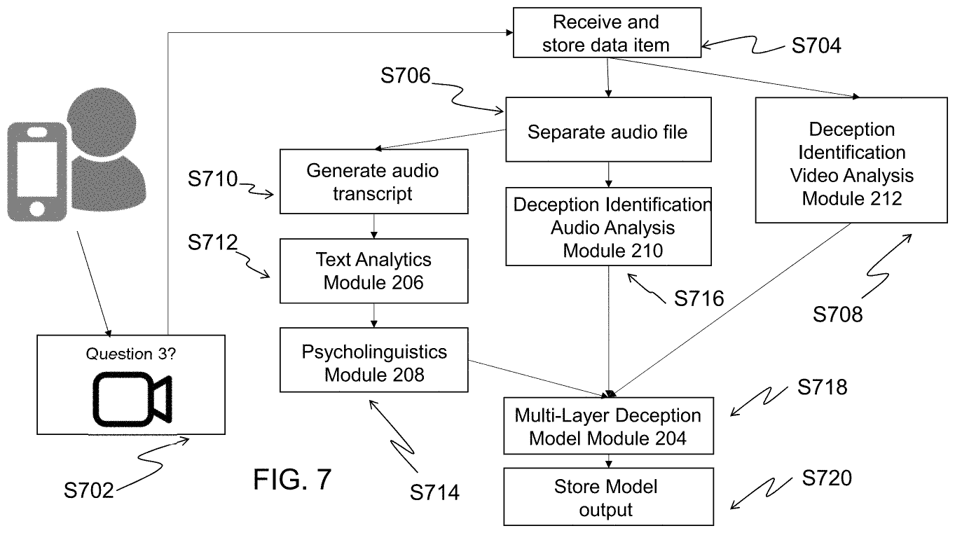

FIG. 7 shows an exemplary process flow for the analysis of a data item that is a video file. A video file data item is generated by the video camera and audio recording facilities (e.g., microphone) on the computing device 110 when the individual 100 answers a question. In step S702, a video file data item is generated that contains the answer to a specific question that is part of the individual's 100 interview. At step S704, the video file data item (which also contains an audio file) is transmitted to the server 130 for further analysis, and the video file data item is received by the server 130 and stored. Next, a three-path analysis process begins as shown in FIG. 7. One path of analysis, at step S708, for the audio file is to perform audio analytics and extract features used to feed a machine learning model (e.g., Machine Learning Model 216) trained to detect deception on visual material. In an exemplary embodiment, this can be obtained by using third-party solutions for the extraction of features from a video file. Eyeris is an example of a company that provides such a solution (http://emovu.com/e/). The second and third paths (starting at S706) consist of separating the audio file from the video file (S706), and processing the resulting audio file in the same steps described above with respect to FIGS. 6 (S606, S608, S610, and S612). These steps include generating an audio transcript from the audio file obtained from the video file (step S710) and analyzing the resulting text file (i.e., audio transcript) using the process depicted in FIG. 5 (steps S712 and S714). At step S716, the separated audio file is provided to the Deception Identification Audio Analysis Module 210 for analysis. This analysis is the same as performed at step S608 of FIG. 6. This three-part analysis generates cross-references among unstructured data items, and increases the capabilities of the disclosed system to detect deception events by correlations, validations, and data redundancy. In step S718, the data resulting from the three paths of analysis are inputted into the Multi-Layer Deception Model Module 204. At step S720, the output of the Multi-Layer Deception Model Module 204 is stored in the server 130 or a database.

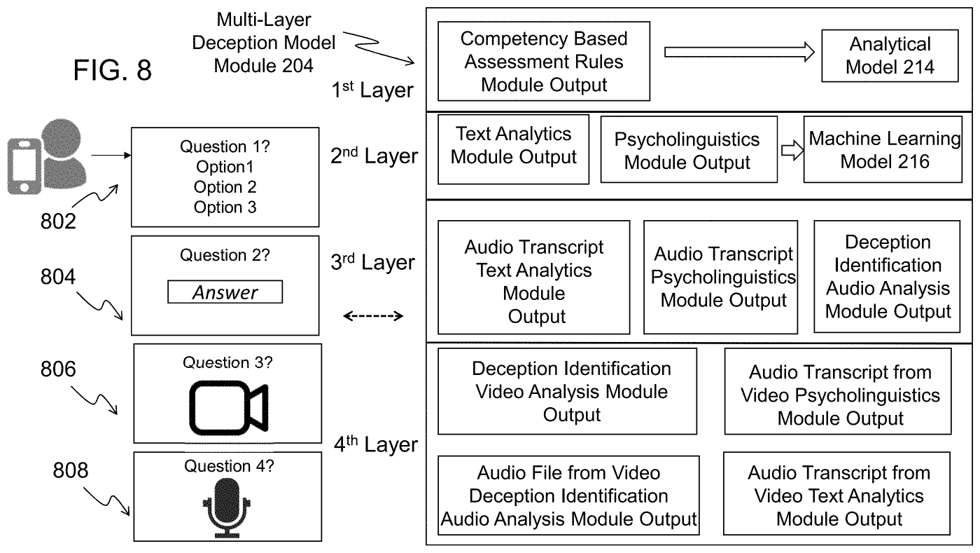

FIG. 8 shows the Multi-Layer Deception Model Module 204 in accordance with an exemplary embodiment. The Multi-Layer Deception Model Module 204 receives as inputs the results of the different analyses performed on the collected data items during the individual's 100 interview. These data items can be the answer selections to multiple choice questions 802, answers in the form of open-ended text data items 804, answers in the form of video recordings 806, and/or answers in the form of audio files 808, as mentioned in regard to FIGS. 3-7. The outputs generated by the different operations of analysis depicted in FIGS. 3-7, are stored in the Multi-Layer Deception Model Module 204. The various outputs are the results of applying different analysis techniques to individual data items and generating cross-references among unstructured data items collected during the individual's 100 interview.

As shown in FIG. 8, the Multi-Layer Deception Model Module 204 includes a multi-layered model consisting of the following four layers: the first layer is the output of the Competency Based Assessment Rules Module 202 represented by structured data items (answers to multiple choice questions), the second layer is the direct analysis of unstructured text data items using natural language processing techniques and psycholinguistics methods (i.e., the outputs of the Text Analytics Module 206 and the Psycholinguistics Module 208). The third layer is the direct analysis of unstructured audio data items and the generation of cross-references using the audio transcript and applying natural language processing techniques and psycholinguistics methods (i.e., the Text Analytics Module 206 output based on analyzing the audio transcript text, the Psycholinguistics Module 208 output based on analyzing the audio transcript text, and the output of the Deception Identification Audio Analysis Module 210. The fourth layer is the direct analysis of video data items, and generating cross-references using the audio file separated from the video and performing direct analysis of the unstructured audio file and using also the transcript from the separated audio of the video data item and applying natural language processing techniques and psycholinguistics methods (i.e., the output of the Deception Identification Video Analysis Module 212, the Psycholinguistics Module 208 output based on analyzing the audio transcript from video, the output of the Deception Identification Audio Analysis Module 210 based on analyzing the audio file separated from the video, and the output of the Text Analytics Module 206 based on analyzing the audio transcript from video. Thus, the server 130 generates ten data sources that are fed into the Multi-Layer Deception Model Module 204. One of these ten data sources is structured data (i.e., the output of the Competency Based Assessment Rules Module) and the nine other data sources are unstructured data. The multi-level model for deception detection performed by the Multi-Layer Deception Model Module 204 can determine deception probability in three levels: probability of deception per question, probability of deception per an assessed competency area of the individual 100, and an overall deception probability of the complete interview of the individual 100. For example, the probability of deception of the first question is calculated to be 0.6, the probability of deception for competency area A is calculated to be 0.4, and the overall probability of deception for the individual's interview is 0.2. In an exemplary embodiment, instead of determining the deception probability at all three levels, the deception probability is determined at one or more levels.

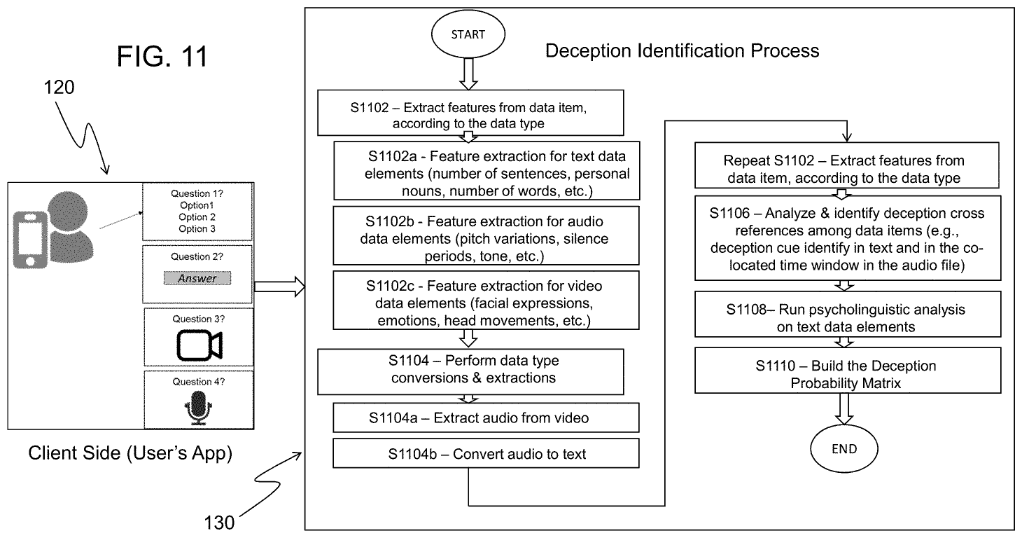

There are some steps of analysis that are common to the three different data types (i.e., open-ended text, an audio recording, and a video recording). These steps are shown in FIG. 11, and will be explained next. The process flow starts by the server 130 receiving the different data types from the user application 120 on the computing device 110. Step S1102 includes extracting corresponding features for each of the data types. For text, the features are extracted using text analytics and these are characteristics like number of words, sentences, verb tenses, personal pronouns, etc. (see step S1102a). For audio, the features that are extracted are related to audio processing techniques, for example, silences in the audio recording, changes in voice pitch, pauses, hesitation, etc. (see step S1102b). For video, the features are extracted using video processing techniques and are characteristics like head movements, facial expressions, eye movement, etc. (see step S1102c). Step S1104 includes performing data type conversions and extractions, and includes substeps S1104a and S1104b. Step S1104a includes extracting audio data from video data. Step S1104b includes converting audio data to text data.

Next, step S1102 is repeated, and features are extracted from the data item according to the data type. Step S1106 includes identifying and analyzing deception cross-references among data items (e.g., identifying deception cues in text and in the co-located time window in the audio file). Step S1108 includes running psycholinguistic analysis on text data elements. Once all relevant features are extracted, these are fed into a machine learning model (e.g. a machine learning model in the Machine Learning Module 216), for example, a random forest or neural networks, etc. These models are trained using a historical dataset and the output is a confidence value on the individual's response, or deception probability. In step S1110, all of these confidence values form the Deception Probability Matrix 1202, an example of which is shown in FIG. 12. The Deception Probability Matrix 1202 is the input for the Multi-Layer Deception Model Module 204 where further analytics are performed. The Multi-Layer Deception Model Module 204 defines groups and ranks the individual 100 by considering previous candidates' evaluations.

An example of the process flow of FIG. 11 is that one of the questions prompts a message to the individual 100 asking for a video recording of the answer. The individual 100 responds to this request and the application 120 sends a video recording to the server 130 for analysis. When the recording is received, the following steps of the deception identification process described in FIG. 11 are performed:
a) analyzing the video recording to extract associated features for analysis;
b) extracting audio from the video recording;
c) generating a transcript of the audio that is extracted from the video recording;
d) analyzing the extracted audio to obtain associated features for analysis;
e) analyzing the generated transcript to extract features for analysis;
f) generating a probability of deception for the video recording, the extracted audio, and the generated transcript; and
g) performing cross-reference analysis.
   In the cross-reference analysis of step g), additional probability values are calculated based on initial analysis values from previous steps, as an example:

Video recording=0.7 (high probability of deception)

Audio recording=0.3 (low probability of deception)

Cross reference=0.5 (medium probability of deception)

In this example, there is a high probability of deception resulting from the isolated analysis of the video recording (0.7), but separating and analyzing the audio from the video results in a low probability (0.3) of deception. Therefore, it can be considered a lower probability of deception (0.5) when the two data items are considered for the same data item.

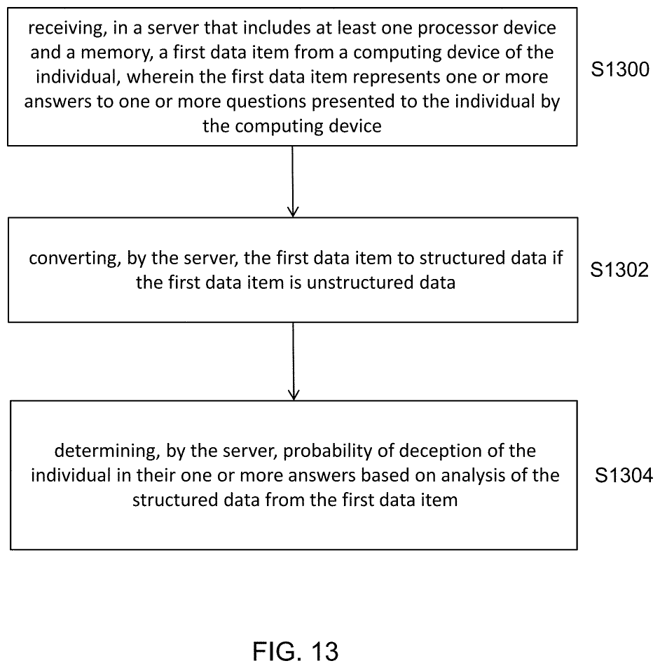

FIG. 13 illustrates a method for detecting deception of an individual 100 in accordance with an exemplary embodiment. The method includes, at step S1300, receiving, in a server 130 that includes at least one processor device and a memory, a first data item from a computing device 110 of the individual 100, wherein the first data item represents one or more answers to one or more questions presented to the individual 100 by the computing device 110. The method includes, at step S1302, converting, by the server 130, the first data item to structured data if the first data item is unstructured data. The method includes, at step S1304, determining, by the server 130, probability of deception of the individual 100 in their one or more answers based on analysis of the structured data from the first data item.

In an exemplary embodiment, the converting includes analyzing the unstructured data of the first data item and extracting parts of the unstructured data or identifying characteristics of the unstructured data.

In an exemplary embodiment, the probability of deception is a number value that indicates a confidence level of the deception.

In an exemplary embodiment, the first data item is an answer to a multiple choice question, the first data item is an answer to the one or more questions provided by the individual 100 in the form of text, the first data item is an audio recording of the individual 100 providing an answer to the one or more questions, or the first data item is a video recording of the individual 100 providing an answer to the one or more questions.

In an exemplary embodiment, when the first data item is the audio recording of the individual 100 providing the answer to the one or more questions, the method includes: generating a transcript of the audio recording, analyzing the transcript for indications of deception, analyzing the audio recording for indications of deception, and comparing a deception event at a time in the transcript to a corresponding time in the audio recording to determine the probability of the deception.

In an exemplary embodiment, when the first data item is the video recording of the individual 100 providing the answer to the one or more questions, the method includes: separating recorded audio corresponding to the video recording from the video recording, generating a transcript of the recorded audio, analyzing the transcript of the recorded audio for indications of deception, analyzing the audio recording for indications of deception, and analyzing the video recording for indications of deception. The method also includes comparing a deception event at a time in the transcript to a corresponding time in the recorded audio and a corresponding time in the video recording to determine the probability of the deception.

In an exemplary embodiment, the method includes receiving, in the server 130, a second data item from the computing device 110 of the individual 100. The second data item represents one or more answers to one or more questions presented to the individual 100 by the computing device 110. The method also includes converting, by the server 130, the second data item to structured data if the second data item is unstructured data. The determining of the probability of deception of the individual 100 is based on the structured data from the first data item and the structured data from the second data item.

In an exemplary embodiment, the first data item is a first type of data, and the second data item is a second type of data.

In an exemplary embodiment, the first type of data is one of text data, audio data, or video data and the second type of data is one of text data, audio data, or video data, and the first type of data is different than the second type of data.

In an exemplary embodiment, the method includes comparing, by the server 130, structured data from the first data item with structured data from the second data item.

In an exemplary embodiment, the method includes receiving, in the server 130, a third data item from the computing device 110 of the individual 100. The third data item represents one or more answers to one or more questions presented to the individual 100 by the computing device 110. The method also includes converting, by the server 130, the third data item to structured data if the third data item is unstructured data. The determining of the probability of deception of the individual 100 is based on the structured data from the first data item, the structured data from the second data item, and the structured data from the third data item.

In an exemplary embodiment, the method includes receiving, in the server 130, a fourth data item from the computing device 110 of the individual 100. The fourth data item represents one or more answers to one or more questions presented to the individual 100 by the computing device 110. The method also includes converting, by the server 130, the fourth data item to structured data if the fourth data item is unstructured data. The determining of the probability of deception of the individual 100 is based on the structured data from the first data item, the structured data from the second data item, the structured data from the third data item, and the structured data from the fourth data item.

In an exemplary embodiment, the first data item is an answer to a multiple choice question provided by the individual 100, the second data item is an answer to the one or more questions provided by the individual 100 in the form of text, the third data item is an audio recording of the individual 100 providing an answer to the one or more questions, and the fourth data item is a video recording of the individual 100 providing an answer to the one or more questions.

In an exemplary embodiment, the first data item is in a form of a data file and the second data item is in a form of a data file.

In an exemplary embodiment, the server 130 determines whether the computing device 100 has a microphone, video camera, and keyboard or touch screen, and based on this determination the server 130 determines whether a response to a question presented to the individual will be in the form of an answer to a multiple choice question provided by the individual 100, an answer to a question provided by the individual 100 in the form of text, an audio recording of the individual 100 providing an answer to a question, or a video recording of the individual 100 providing an answer to a question.

In an exemplary embodiment, the disclosed system can be used to evaluate the competencies of the individual. For example, to assess the leadership of the individual 100. For example, the individual could be asked to rate their leadership skill, and they could rate themselves as a 5 out of 5, and if there is not detected deception, it can be determined that the individual 100 does indeed have a level of leadership. In an exemplary embodiment, the disclosed system can be used to determine psychological profile of an individual. For example, the individual's 100 answers to specific questions could indicate whether the individual is an introvert, extrovert, etc.

FIG. 14 is a block diagram illustrating an architecture of a computing device 1400 in accordance with an exemplary embodiment that can be used for the computing device 110 and the server 130 shown in FIGS. 1 and 2. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A hardware processor device as discussed herein may be a single hardware processor, a plurality of hardware processors, or combinations thereof. Hardware processor devices may have one or more processor “cores.” The term “non-transitory computer readable medium” as discussed herein is used to generally refer to tangible media such as a memory device 220 and main memory 1404.

Various embodiments of the present disclosure are described in terms of this exemplary computing device 1400. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Hardware processor 1402 may be a special purpose or a general purpose processor device. The hardware processor device 1402 may be connected to a communications infrastructure 1410, such as a bus, message queue, network, multi-core message-passing scheme, etc. The network shown in FIGS. 1 and 8 may be any network suitable for performing the functions as disclosed herein and may include a local area network (LAN), a wide area network (WAN), a wireless network (e.g., Wi-Fi), a mobile communication network, a satellite network, the Internet, fiber optic, coaxial cable, infrared, radio frequency (RF), or any combination thereof. Other suitable network types and configurations will be apparent to persons having skill in the relevant art. The computing device 1400 may also include a memory 1404 (e.g., random access memory, read-only memory, etc.), and may also include one or more additional memories. The memory 1404 and the one or more additional memories may be read from and/or written to in a well-known manner. In an embodiment, the memory 1404 and the one or more additional memories may be non-transitory computer readable recording media.

Data stored in the computing device 1400 (e.g., in the memory 1404) may be stored on any type of suitable computer readable media, such as optical storage (e.g., a compact disc, digital versatile disc, Blu-ray disc, etc.), magnetic tape storage (e.g., a hard disk drive), or solid-state drive. An operating system can be stored in the memory 1404.

In an exemplary embodiment, the data may be configured in any type of suitable database configuration, such as a relational database, a structured query language (SQL) database, a distributed database, an object database, etc. Suitable configurations and storage types will be apparent to persons having skill in the relevant art.

The computing device 1400 may also include a communications interface 1412. The communications interface 1412 may be configured to allow software and data to be transferred between the computing device 1400 and external devices. Exemplary communications interfaces 1412 may include a modem, a network interface (e.g., an Ethernet card), a communications port, a PCMCIA slot and card, etc. Software and data transferred via the communications interface 1412 may be in the form of signals, which may be electronic, electromagnetic, optical, or other signals as will be apparent to persons having skill in the relevant art. The signals may travel via a communications path 1414, which may be configured to carry the signals and may be implemented using wire, cable, fiber optics, a phone line, a cellular phone link, a radio frequency link, etc.

Memory semiconductors (e.g., DRAMs, etc.) may be means for providing software to the computing device 1400. Computer programs (e.g., computer control logic) may be stored in the memory 1404. Computer programs may also be received via the communications interface 1412. Such computer programs, when executed, may enable computing device 1400 to implement the present methods as discussed herein. In particular, the computer programs stored on a non-transitory computer-readable medium, when executed, may enable hardware processor device 1402 to implement the methods illustrated by FIGS. 4-7 and 13, or similar methods, as discussed herein. Accordingly, such computer programs may represent controllers of the computing device 1400. Where the present disclosure is implemented using software, the software may be stored in a computer program product or non-transitory computer readable medium and loaded into the computing device 1400 using a removable storage drive or communications interface 1412.

The computing device 1400 may also include a display interface 1406 that outputs display signals to a display unit 1408, e.g., LCD screen, plasma screen, LED screen, DLP screen, CRT screen, etc.

Where the present disclosure is implemented using software, the software may be stored in a computer program product or non-transitory computer readable medium and loaded into one or more of the computing device 100 and the server 130 using a removable storage drive or a communications interface.

Thus, it will be appreciated by those skilled in the art that the disclosed systems and methods can be embodied in other specific forms without departing from the spirit or essential characteristics thereof. The presently disclosed embodiments are therefore considered in all respects to be illustrative and not restricted. It is not exhaustive and does not limit the disclosure to the precise form disclosed. Modifications and variations are possible in light of the above teachings or may be acquired from practicing of the disclosure, without departing from the breadth or scope. Reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. The scope of the invention is indicated by the appended claims rather than the foregoing description and all changes that come within the meaning and range and equivalence thereof are intended to be embraced therein.

What is claimed is:

1. A method for detecting deception of an individual, the method comprising:
receiving, in a server that includes at least one processor device and a memory, a first data item from a computing device of the individual, wherein the first data item represents one or more answers to one or more questions presented to the individual by the computing device;
converting, by the server, the first data item to structured data if the first data item is unstructured data; and
determining, by the server, probability of deception of the individual in their one or more answers based on analysis of the structured data from the first data item.

2. The method of claim 1, wherein the converting includes analyzing the unstructured data of the first data item and extracting parts of the unstructured data or identifying characteristics of the unstructured data.

3. The method of claim 1, wherein the probability of deception is a number value that indicates a confidence level of the deception.

4. The method of claim 1, wherein the first data item is an answer to a multiple choice question, the first data item is an answer to the one or more questions provided by the individual in the form of text, the first data item is an audio recording of the individual providing an answer to the one or more questions, or the first data item is a video recording of the individual providing an answer to the one or more questions.

5. The method of claim 4, wherein when the first data item is the audio recording of the individual providing the answer to the one or more questions, the method includes:
generating a transcript of the audio recording,
analyzing the transcript for indications of deception,
analyzing the audio recording for indications of deception, and
comparing a deception event at a time in the transcript to a corresponding time in the audio recording to determine the probability of the deception.

6. The method of claim 4, wherein when the first data item is the video recording of the individual providing the answer to the one or more questions, the method includes:
separating recorded audio corresponding to the video recording from the video recording,
generating a transcript of the recorded audio,
analyzing the transcript of the recorded audio for indications of deception,
analyzing the audio recording for indications of deception,
analyzing the video recording for indications of deception, and
comparing a deception event at a time in the transcript to a corresponding time in the recorded audio and a corresponding time in the video recording to determine the probability of the deception.

7. The method of claim 1, further comprising:
receiving, in the server, a second data item from the computing device of the individual, wherein the second data item represents one or more answers to one or more questions presented to the individual by the computing device; and
converting, by the server, the second data item to structured data if the second data item is unstructured data,
wherein the determining of the probability of deception of the individual is based on the structured data from the first data item and the structured data from the second data item.

8. The method of claim 7, wherein the first data item is a first type of data, and the second data item is a second type of data.

9. The method of claim 8, wherein the first type of data is one of text data, audio data, or video data and the second type of data is one of text data, audio data, or video data, and the first type of data is different than the second type of data.

10. The method of claim 7, further comprising:
comparing, by the server, structured data from the first data item with structured data from the second data item.

11. The method of claim 7, further comprising:
receiving, in the server, a third data item from the computing device of the individual, wherein the third data item represents one or more answers to one or more questions presented to the individual by the computing device; and
converting, by the server, the third data item to structured data if the third data item is unstructured data,
wherein the determining of the probability of deception of the individual is based on the structured data from the first data item, the structured data from the second data item, and the structured data from the third data item.

12. The method of claim 11, further comprising:
receiving, in the server, a fourth data item from the computing device of the individual, wherein the fourth data item represents one or more answers to one or more questions presented to the individual by the computing device; and
converting, by the server, the fourth data item to structured data if the fourth data item is unstructured data,
wherein the determining of the probability of deception of the individual is based on the structured data from the first data item, the structured data from the second data item, the structured data from the third data item, and the structured data from the fourth data item.

13. The method of claim 12, wherein the first data item is an answer to a multiple choice question provided by the individual, the second data item is an answer to the one or more questions provided by the individual in the form of text, the third data item is an audio recording of the individual providing an answer to the one or more questions, and the fourth data item is a video recording of the individual providing an answer to the one or more questions.

14. The method of claim 2, wherein the first data item is in a form of a data file and the second data item is in a form of a data file.

15. The method of claim 1, wherein the server determines whether the computing device has a microphone, video camera, and keyboard or touch screen, and based on this determination the server determines whether a response to a question presented to the individual will be in the form of an answer to a multiple choice question provided by the individual, an answer to a question provided by the individual in the form of text, an audio recording of the individual providing an answer to a question, or a video recording of the individual providing an answer to a question.

16. The method of claim 1, wherein the first data item is text data, and the method includes extracting personality traits of the individual based on analysis of the text data.

17. A server configured to detect deception of an individual, the server comprising:
a memory; and
at least one processor device,
wherein the server is configured to:
receive a first data item from a computing device of the individual,
wherein the first data item represents one or more answers to one or more questions presented to the individual by the computing device,
convert the first data item to structured data if the first data item is unstructured data, and
determine probability of deception of the individual in their one or more answers based on analysis of the structured data from the first data item.

18. The server of claim 17, wherein when the first data item is unstructured data, the server is configured to:
convert the first data item to structured data,
extract parts of the unstructured data or identify characteristics of the unstructured data, and
analyze the unstructured data of the first data item.

19. The server of claim 17, wherein the probability of deception is a number value that indicates a confidence level of the deception.

20. The server of claim 17, wherein the first data item is an answer to a multiple choice question, the first data item is an answer to the one or more questions provided by the individual in the form of text, the first data item is an audio recording of the individual providing an answer to the one or more questions, or the first data item is a video recording of the individual providing an answer to the one or more questions.

21. The server of claim 20, wherein when the first data item is the audio recording of the individual providing the answer to the one or more questions, the server is configured to:
generate a transcript of the audio recording,
analyze the transcript for indications of deception,
analyze the audio recording for indications of deception, and
compare a deception event at a time in the transcript to a corresponding time in the audio recording to determine the probability of the deception.

22. The server of claim 20, wherein when the first data item is the video recording of the individual providing the answer to the one or more questions, the server is configured to:
separate recorded audio corresponding to the video recording from the video recording,
generate a transcript of the recorded audio,
analyze the transcript of the recorded audio for indications of deception,
analyze the audio recording for indications of deception,
analyze the video recording for indications of deception, and
compare a deception event at a time in the transcript to a corresponding time in the recorded audio and a corresponding time in the video recording to determine the probability of the deception.

23. The server of claim 17, wherein the server is configured to:
receive a second data item from the computing device of the individual, wherein the second data item represents one or more answers to one or more questions presented to the individual by the computing device;
convert the second data item to structured data if the second data item is unstructured data; and
determine the probability of deception of the individual based on the structured data from the first data item and the structured data from the second data item.

24. The server of claim 23, wherein the first data item is a first type of data, and the second data item is a second type of data.

25. The server of claim 24, wherein the first type of data is one of text data, audio data, or video data and the second type of data is one of text data, audio data, or video data, and the first type of data is different than the second type of data.

26. The server of claim 23, wherein the server is configured to compare structured data from the first data item with structured data from the second data item.

27. The server of claim 23, wherein the server is configured to:
receive a third data item from the computing device of the individual, wherein the third data item represents one or more answers to one or more questions presented to the individual by the computing device;
convert the third data item to structured data if the third data item is unstructured data; and
determine the probability of deception of the individual based on the structured data from the first data item, the structured data from the second data item, and the structured data from the third data item.

28. The server of claim 27, wherein the server is configured to:
receive a fourth data item from the computing device of the individual, wherein the fourth data item represents one or more answers to one or more questions presented to the individual by the computing device;
convert the fourth data item to structured data if the fourth data item is unstructured data; and
determine the probability of deception of the individual based on the structured data from the first data item, the structured data from the second data item, the structured data from the third data item, and the structured data from the fourth data item.

29. The server of claim 28, wherein the first data item is an answer to a multiple choice question provided by the individual, the second data item is an answer to the one or more questions provided by the individual in the form of text, the third data item is an audio recording of the individual providing an answer to the one or more questions, and the fourth data item is a video recording of the individual providing an answer to the one or more questions.

30. The server of claim 18, wherein the first data item is in a form of a data file and the second data item is in a form of a data file.

31. The server of claim 17, wherein the server is configured to determine whether the computing device has a microphone, video camera, and keyboard or touch screen, and based on this determination the server is configured to determine whether a response to a question presented to the individual will be in the form of an answer to a multiple choice question provided by the individual, an answer to a question provided by the individual in the form of text, an audio recording of the individual providing an answer to a question, or a video recording of the individual providing an answer to a question.
